(19) United States
(12) Patent Application Publication
(10) Pub. No.: US 2013/0300025 A1
(43) Pub. Date: Nov. 14, 2013

(54) METHODS OF TREATING A MOLD AND FORMING A SOLID LAYER OF A SEMICONDUCTING MATERIAL THEREON

(71) Applicant: Corning Incorporated, Corning, NY (US)

(72) Inventors: Glen Bennett Cook, Elmira, NY (US); Prantik Mazumder, Ithaca, NY (US); John Paul Bir Singh, Painted Post, NY (US)

(73) Assignee: Corning Incorporated, Corning, NY (US)

(21) Appl. No.: 13/841,773

(22) Filed: Mar. 15, 2013

Related U.S. Application Data
(60) Provisional application No. 61/644,758, filed on May 9, 2012.

(51) Int. Cl. B29C 33/56

(52) U.S. Cl. CPC B29C 33/56
USPC 264/219; 425/90

(57) ABSTRACT

A method of forming a solid layer of a semiconducting material on an external surface of a treated mold which extends between a leading edge and a trailing edge comprises selectively modifying a temperature gradient of a mold such that a temperature of the leading edge (T₁) is less than a temperature of the trailing edge (T₂) to form the treated mold. The method further comprises submersing the treated mold into a molten semiconducting material such that the leading edge of the treated mold is first submersed into the molten semiconducting material. The method also comprises withdrawing the treated mold from the molten semiconducting material to form the solid layer of the semiconducting material on the external surface of the treated mold.

### CROSS-REFERENCE TO RELATED APPLICATIONS

This application claims the benefit of priority under 35 U.S.C. §119 of U.S. Provisional Application Ser. No. 61/644,758 filed on May 9, 2012, the content of which is relied upon and incorporated herein by reference in its entirety.

### BACKGROUND

The disclosure generally relates to a method of treating a mold, methods of forming a solid layer of a semiconducting material on an external surface of a treated mold, and the solid layer of the semiconducting material.

Semiconducting materials are used in a variety of applications, and may be incorporated, for example, into electronic devices such as photovoltaic devices. The properties of semiconducting materials may depend on a variety of factors, including crystal structure, the concentration and type of intrinsic defects, and the presence and distribution of dopants and other impurities. Within a semiconducting material, the grain size and grain size distribution, for example, can impact the performance of resulting devices. One type of semiconducting material is silicon, which may be formed via a variety of techniques. Examples include silicon formed as an ingot, sheet or ribbon. The silicon may be supported or unsupported by an underlying substrate.

Solid layers of semiconducting materials can be prepared by a variety of methods. One method of forming such solid layers is referred to as an exocasting process in which a mold is dipped into a molten semiconducting material and removed from the molten semiconducting material. A solid layer forms on surfaces of the mold, which can subsequently be removed and refined or otherwise utilized. However, in prior exocasting methods, the solid layer of the semiconducting material has a non-uniform thickness, which results in undesirable physical properties and material loss.

### SUMMARY

The disclosure provides a method of treating a mold to form a treated mold for use in forming an article of a semiconducting material on an external surface of the treated mold. The mold extends between a leading edge and a trailing edge and the method comprises selectively modifying a temperature gradient of the mold such that a temperature of the leading edge (T₁) is less than (e.g., at least 50° C. less than) a temperature of the trailing edge (T₂).

The disclosure also provides a method of forming a solid layer of a semiconducting material on an external surface of a treated mold. The method comprises selectively modifying a temperature gradient of a mold which extends between a leading edge and a trailing edge such that a temperature of the leading edge (T₁) is less than a temperature of the trailing edge (T₂) to form the treated mold. The method further comprises submersing the treated mold into a molten semiconducting material such that the leading edge of the treated mold is first submersed into the molten semiconducting material. Finally, the method comprises withdrawing the treated mold from the molten semiconducting material such that the leading edge of the treated mold is last withdrawn from the molten semiconducting material to form the solid layer of the semiconducting material on the external surface of the treated mold.

The disclosure also provides a solid layer of a semiconducting material formed in accordance with the method.

### BRIEF DESCRIPTION OF THE DRAWINGS

Other advantages and aspects may be described in the following detailed description when considered in connection with the accompanying drawings wherein:

FIG. 1 is a graph of a thickness of a solid layer versus submersion time for various mold temperatures according to one embodiment;

FIG. 2 is a graph of a thickness of a solid layer versus submersion time for various mold temperatures according to another embodiment; and

FIG. 3 is a graph of lead edge temperature versus submersion rate according to various embodiments.

### DETAILED DESCRIPTION OF THE DISCLOSURE

The disclosure provides a method of treating a mold which extends between a leading edge and a trailing edge to form a treated mold. The disclosure also provides a method of forming a solid layer of a semiconducting material on an external surface of the treated mold. The solid layer of the semiconducting material formed with the method is particularly suitable for electronics components and devices, such as microprocessors and photovoltaic cell modules.

The treated mold is generally utilized in, and the method of forming the solid layer of the semiconducting material is generally referred to as, an exocasting process. In an exocasting process, a mold is submersed into and then withdrawn from a molten semiconducting material. Due in large part to heat loss to the mold and the surroundings, a portion of the molten semiconducting material undergoes a liquid-to-solid phase transformation, which results in the formation of a solid layer of a semiconducting material over an external surface of the mold. In embodiments of the exocasting process, the mold acts as both a heat sink and a solid form for the solidification to occur and may seed crystallization of the solid layer of the semiconducting material.

A mold may be utilized at ambient temperature or at a uniform elevated temperature. Further, because a temperature of the molten semiconducting material is generally higher than a temperature of the mold prior to submersing the mold into the molten semiconducting material, the leading edge of the mold generally has a temperature that is greater than a temperature of the trailing edge of the mold. Specifically, the leading edge of the mold is generally heated due initially to radiative and then conductive and convective heat transfer by the molten semiconducting material as the leading edge of the mold is lowered toward the molten semiconducting material for submersion of the mold therein.

The method of treating the mold comprises selectively modifying a temperature gradient of the mold such that a temperature of the leading edge (T₁) prior to submersing the mold is less than (e.g., at least 50° C. less than) a temperature of the trailing edge (T₂) to form the treated mold. Selectively modifying the temperature gradient of the mold may also be referred to herein as selectively modifying a temperature profile of the mold. In the exocasting process, the leading edge of the treated mold is first submersed in the molten semiconducting material.

T₁ and T₂ are typically selected such that T₁ is at least 50° C. less than T₂ at the time at which the treated mold is submersed in the molten semiconducting material. Accordingly, the difference between T₁ and T₂ may be significantly greater than at least 50° C. because T₁ will increase immediately prior to submersing the leading edge in the molten semiconducting material, yet T₁ is at least 50° C. less than T₂ at the time at which the treated mold is submersed in the molten semiconducting material.

The mold and the treated mold are identical but for the temperature gradient of the mold and the treated mold, respectively. Accordingly, descriptions of certain aspects of the mold are also applicable to the treated mold and vice versa, save for T₁ and T₂, which are imparted to the treated mold by selectively modifying the temperature gradient of the mold.

The mold typically comprises a material that is capable of maintaining localized temperature gradients at least until the solid layer of the semiconducting material forms on the external surface of the treated mold. For example, certain materials having high thermal conductivities generally evenly distribute any localized temperature throughout the respective volumes of the materials. Said differently, any localized temperature gradient may be lost in certain materials over small periods of time, e.g. less than one minute, as the temperature of the material equilibrates. However, the mold generally comprises a material that can maintain localized temperature gradients for an extended period of time, i.e., T₁ and T₂ do not readily equilibrate in the treated mold.

The mold may be in the form of a monolith or wafer. Further, the mold may comprise a porous or a non-porous body, optionally having one or more porous or non-porous coatings. The mold may present one or more flat external surfaces or one or more curved external surfaces. A curved external surface may be convex or concave. The mold and its external surfaces may be characterized by features including shape, dimension, surface area, surface roughness, etc. One or more of these features may be uniform or non-uniform.

In certain embodiments, the mold typically has a substantially uniform thickness between the leading edge and the trailing edge. In particular, the mold has two dimensions perpendicular to the axis which extends between the leading edge and the trailing edge, and the thickness of the mold may refer to either or both of these dimensions, i.e., the mold has substantially uniform dimensions other than the dimension in which the mold extends between the leading edge and the trailing edge. Accordingly, the mold typically has a substantially uniform cross section and cross-sectional area along an axis extending between the leading edge and the trailing edge of the mold. The mold typically has a generally rectangular shape, although other shapes may alternatively be utilized. The phrase “substantially uniform,” as used herein with reference to the thickness, dimensions, or cross sectional areas of the mold, means a variation of less than 30, alternatively less than 20, alternatively less than 10, alternatively less than 5, alternatively less than 2, alternatively less than 1, percent.

The thickness of the mold can range from about 0.1 to 100 millimeters (mm) (e.g. 0.1, 0.2, 0.5, 1, 2, 5, 10, 20, 50 or 100 mm). The other dimension of the mold that is perpendicular to the axis which extends between the leading edge and the trailing edge may vary from about 1 cm to 100 cm or greater. Similarly, the length of the mold along the axis which extends between the leading edge and the trailing edge may vary from about 1 cm to 100 cm or greater.

The material of the mold is compatible with the molten semiconducting material. For example, the material is compatible with the molten semiconducting material if the mold does not melt from the molten semiconducting material or soften when submersed in the molten semiconducting material. As a further example, the mold may be thermally stable and/or chemically inert to the molten semiconducting material, and therefore non-reactive or substantially non-reactive with the molten semiconducting material. In addition, the material of the mold is selected so as to ensure that the mold does not impart undesirable impurities into the solid layer of the semiconducting material.

Specific examples of materials suitable for the mold include refractory materials such as fused silica, graphite, silicon nitride, silicon carbide, single crystal or polycrystalline silicon, as well as combinations and composites of these materials. In certain embodiments, the material of the mold is vitreous silicon dioxide or quartz.

While the difference between T₁ and T₂ may be selected independent of the material of the mold, T₁ and T₂ may be selected based on the material of the mold. T₁ and T₂ may independently be above, below, or at ambient temperature. Said differently, selectively modifying a temperature gradient of the mold may comprise differentially heating both the leading edge and the trailing edge of the mold, heating the trailing edge of the mold but not the leading edge of the mold, heating the trailing edge of the mold and cooling the trailing edge of the mold, differentially cooling both the leading edge and the trailing edge of the mold, or cooling the leading edge of the mold but not the trailing edge of the mold.

The temperature profile of the mold may be selectively modified by any method. For example, when the leading edge and/or the trailing edge are heated, the leading edge and/or the trailing edge may be heated via any method capable of transferring heat to the leading edge and/or the trailing edge. The leading edge and/or the trailing edge may be heated via a heating element, which may be in direct contact with the leading edge and/or the trailing edge, or may be spaced from the heating element such that the leading edge and/or the trailing edge are heated via radiant heat transfer from the heating element. Most typically, the leading edge and/or the trailing edge are spaced from the heating element to minimize risk of transferring impurities from the heating element to the mold. Alternatively, when the leading edge and/or the trailing edge are cooled, the leading edge and/or the trailing edge may be cooled via any method capable of removing heat from the leading edge and/or the trailing edge. For example, the leading edge and/or the trailing edge may be cooled by refrigeration, e.g. non-cyclic, cyclic, thermoelectric, and/or magnetic refrigeration. Further, the leading edge and/or the trailing edge may be cooled via direct contact with a cooling medium, such as liquid argon or liquid helium. Alternatively, the leading edge and/or the trailing edge may be cooled via passive cooling. As one example of a method of imparting the mold with the temperature profile, the trailing edge of the mold could be held above the molten semiconducting material and, once the trailing edge of the mold is heated to a desired temperature to form the treated mold, the mold could be inverted such that the leading edge of the mold is first submersed into the molten semiconducting material.

In certain embodiments in which the molten semiconducting material is molten silicon, T₁ is from 150 to 250° C., alternatively from 175 to 225° C., and T₂ is from 300 to 500° C., alternatively from 325 to 475° C., alternatively from 350 to 450° C. T₁ and T₂ are selected based on the material of the mold, dimensions of the mold, the particular molten semiconducting material employed, and the parameters of the exocasting process. Specifically, the heat of fusion of the molten semiconducting material influences the selection of T₁ and T₂ such that T₁ and T₂ may vary from the ranges set forth above. While these ranges for T₁ and T₂ are above ambient temperature, the leading edge of the mold is often heated by the molten semiconducting material prior to its submersion therein such that the leading edge of the mold may be cooled yet still have a temperature within the range above prior to being submersed in the molten semiconducting material.

The disclosure also provides a method of forming a solid layer of a semiconducting material on an external surface of a treated mold. The treated mold may be the treated mold described above with reference to the method of treating a mold. Similarly, the mold may be the mold described above with reference to the method of treating a mold.

The method comprises selectively modifying a temperature gradient of a mold such that a temperature of the leading edge (T₁) is less than a temperature of the trailing edge (T₂) to form the treated mold. The method further comprises submersing the treated mold into a molten semiconducting material such that the leading edge of the treated mold is first submersed into the molten semiconducting material. Finally, the method comprises withdrawing the treated mold from the molten semiconducting material such that the leading edge of the treated mold is last withdrawn from the molten semiconducting material to form the solid layer of the semiconducting material on the external surface of the treated mold.

Because the leading edge of the treated mold is submersed in the molten semiconducting material before the trailing edge of the treated mold, and because the leading edge of the treated mold is last withdrawn from the molten semiconducting material, the leading edge of the treated mold is submersed for a longer period of time than the trailing edge of the treated mold. Without this temperature profile, this time dispersion along a length of the treated mold, i.e., a length between the leading edge and the trailing edge in the direction of submersion and withdrawal, can introduce variability in the properties of the solid layer of the semiconducting material, including a thickness thereof. As disclosed herein, the effects of the time dispersion can be minimized by selectively modifying the temperature gradient of the mold to form the treated mold, and utilizing the treated mold in the exocasting process. By selectively modifying the temperature gradient of the mold to form the treated mold, the effect on the thickness and thickness variability of the solid layer due to the residence time difference between the leading and trailing edges of the treated mold can be minimized.

Prior exocasting methods have utilized various mold geometries for attempting to obtain solid layers of semiconducting materials. In particular, certain mold geometries, e.g. trapezoid or wedge-shaped molds, can at least partially offset the thickness variations of the solid layers of semiconducting materials because such mold geometries at least partially obviate the different residence times of the leading and trailing edges of such molds. However, these molds require specific machining and are generally only able to a specific target thickness. However, the instant treated mold and method overcome these deficiencies by providing a solid layer of semiconducting material having a substantially uniform thickness even when the instant treated mold has a substantially uniform thickness and cross-sectional area. Further, the temperatures of the leading and trailing edges can be selectively modified to form different treated molds for preparing solid layers of semiconducting materials having different substantially uniform thicknesses, i.e., the same mold may be utilized to form different treated molds at different times.

In various embodiments of the method, a target thickness is selected for the solid layer of the semiconducting material. Plots of the thickness of the solid layer versus submersion time are then calculated for a mold having particular attributes, including the material of the treated mold and the dimensions of the treated mold, and submersion times corresponding to a submersion rate and a withdrawal rate. On the basis of these parameters, T₁ and T₂ may can be calculated and utilized to offset the difference in total residence time between the leading and trailing edges of the treated mold in order to minimize the total thickness variability of the solid layer of the semiconducting material. According to various embodiments, by adjusting T₁ and T₂ such that T₁ is less than T₂, differences in residence time relative to the leading and trailing edges will not lead to corresponding variations in the thickness of the solid layer of the semiconducting material, with all other parameters of the exocasting process being equal.

The molten semiconducting material is generally disposed in a vessel. The molten semiconducting material may be provided or obtained by melting a suitable semiconducting material in the vessel. The vessel is generally formed from a high temperature or refractory material chosen from vitreous silica, graphite, and silicon nitride. Alternatively, the vessel may be formed from a first high temperature or refractory material and provided with an internal coating of a second high temperature or refractory material where the internal coating is adapted to be in contact with the molten semiconducting material. The semiconducting material may be silicon. In addition to silicon, the molten semiconducting material may be chosen from alloys and compounds of silicon, germanium, alloys and compounds of germanium, gallium arsenide, alloys and compounds of gallium arsenide, and combinations thereof.

The molten semiconducting material may comprise at least one non-semiconducting element that may form a semiconducting alloy or compound. For example, the molten semiconducting material may comprise gallium arsenide (GaAs), aluminum nitride (AlN) or indium phosphide (InP).

According to various embodiments, the molten semiconducting material may be pure or doped. Example dopants, if present, include boron, phosphorous, or aluminum, and may be present in any suitable concentration, e.g. 1-100 ppm, which may be chosen based on, for example, the desired dopant concentration in the solid layer of the semiconducting material.

Submersing the treated mold in the molten semiconducting material comprises at least partially submersing the treated mold into molten semiconducting material, after which the treated mold is withdrawn from the molten semiconducting material. During submersion and withdrawal, the molten semiconducting material solidifies and forms the solid layer of the semiconducting material over the external surface of the treated mold. The term “trailing edge,” as used herein, means the trailing portion of the treated mold that is submersed in the molten semiconducting material. To this end, when the treated mold is only partially submersed in the molten semiconducting material, the trailing edge of the mold may be a portion of the treated mold other than an actual edge, i.e., end, of the treated mold itself.

In one exemplary embodiment, using any suitable device or method, the temperature gradient of the mold is selectively modified such that, immediately prior to the leading edge of the treated mold being submersed in the molten semiconducting material, T₁ is less than T₂. As such, because the temperature of the leading edge increases as the mold is lowered toward the molten semiconducting material, T₁ may be significantly lower than T₂ to account for the increase in temperature due initially to radiative and then conductive and convective heat transfer from the molten semiconducting material to the leading edge of the mold. As but one example, the temperature of the leading edge of the mold may initially be −50° C., but T₁ may be greater than 100° C. as the leading edge of the mold is heated by the molten semiconducting material immediately prior to the treated mold being submersed in the molten semiconducting material such that the treated mold is formed from the mold immediately prior to submersing the treated mold into the molten semiconducting material. The molten semiconducting material may be brought to a bulk temperature which is greater than or equal to a melt temperature of the semiconducting material.

At least one heating element may be used to heat the vessel and/or maintain the molten semiconducting material at a desired temperature. The heating element may be the same as or different from the heating element utilized to selectively modify the temperature gradient of the mold. Examples of suitable heating elements include resistive or inductive heating elements, infrared (IR) heat sources (e.g., IR lamps), and flame heat sources. An example of an inductive heating element is a radio frequency (RF) induction heating element. RF induction heating may provide a cleaner environment by minimizing the presence of foreign matter in the molten semiconducting material.

A composition of an atmosphere above the molten semiconducting material can be controlled before, during, and/or after submersion of the treated mold. Utilizing vitreous silica for the mold and/or the vessel may lead to oxygen contamination of the solid layer of the semiconducting material. Accordingly, oxygen contamination may be mitigated or substantially mitigated, by melting the semiconducting material and forming the solid layer of the semiconducting material in a low-oxygen environment, comprising, for example, a dry mixture of hydrogen (e.g., less than 1 ppm water) and an inert gas such as argon, krypton or xenon. A low-oxygen environment may include one or more of hydrogen, helium, argon, or nitrogen. In one exemplary embodiment, the atmosphere may be chosen from an Ar/1.0 wt % H₂ mixture or an Ar/2.5 wt % H₂ mixture.

Prior to submersion, the temperature of the molten semiconducting material is typically greater than both the leading edge and the trailing edge of the treated mold, i.e., the temperature of the molten semiconducting material is greater than both T₁ and T₂. In embodiments where the molten semiconducting material comprises silicon, the bulk temperature of the molten silicon may range from 1414 to 1550° C., alternatively from 1450 to 1490° C., e.g. 1460° C. In addition to controlling the temperature gradient of the treated mold and the temperature of the molten semiconducting material, the temperature of the radiant environment, such as a wall of the vessel, may also be controlled.

In embodiments where the mold comprises silica and the molten semiconducting material comprises silicon, a convex meniscus generally forms at the point of entry of the treated mold into the molten silicon because silicon does not readily wet to the external surface of the treated mold.

T₁ is generally less than the temperature of the molten semiconducting material. As the leading edge of the treated mold is submersed into the molten semiconducting material, followed by the trailing edge of the treated mold, a relatively large temperature difference between the treated mold and the molten semiconducting material will induce a liquid-to-solid phase transformation that results in the formation of the solid layer of the semiconducting material over the external surface of the treated mold.

The magnitude of the temperature difference between the treated mold and the molten semiconducting material can affect the microstructure and other properties of the solid layer of the semiconducting material. The relatively large temperature difference between the treated mold and the molten semiconducting material, which may be on the order of 800° C., results in the formation of a Stage I solid layer over the external surface of the treated mold. The Stage I solid layer may comprise a relatively fine grain size.

In embodiments, as the treated mold is submersed, the molten semiconducting material is first solidified at the leading edge of the treated mold. As the treated mold is further submersed, the Stage I solid layer forms over an exposed surface of the treated mold. The growth front of the Stage I solid layer is continuously fed during submersion by molten material from the convex meniscus, and the growth direction of the Stage I solid layer is substantially parallel to the relative direction of motion between the treated mold and the molten semiconducting material, i.e., the growth direction of the Stage I solid layer is substantially parallel to the exposed surface of the treated mold.

The treated mold and/or the vessel may be rotated or vibrated as the treated mold is submersed. Typically, the treated mold is maintained essentially stationary in the transverse dimensions as it is lowered into and raised out of the molten semiconducting material along the axis extending between the leading edge and the trailing edge of the treated mold. Alternatively or in addition, the treated mold may be held stationary and the vessel containing the molten semiconducting material may be moved (i.e., raised) in order to submerse the treated mold within the molten semiconducting material and/or moved (i.e., lowered) in order to withdraw the treated mold from the molten semiconducting material. In embodiments, the entire mold may be submersed or substantially all of the treated mold may be submersed into the molten semiconducting material. For instance, with respect to its length along the axis extending between the leading edge and the trailing edge, 90% or more of the treated mold may be submersed (e.g., 90, 95, 99 or 100%). The terminology “submersing the mold” means that the treated mold is at least partially submersed in the molten semiconducting material but the mold need not be fully submersed. The treated mold may optionally include a handle or other portion extending from the trailing edge. The handle may be held during submersion of the treated mold, and such a handle or portion is not included when determining the length of the treated mold that is submersed in the molten semiconducting material.

With the treated mold at least partially submersed in the molten semiconducting material, the Stage I solid layer which is formed via a growth interface having a growth direction substantially parallel to the external surface of the treated mold becomes the template for the formation of a Stage II solid layer, where molten semiconducting material solidifies at an exposed surface of the Stage I solid layer. Initial formation of the Stage II solid layer, which typically occurs at a lower temperature differential than Stage I growth, can increase the thickness of the solid layer. Thus, in contrast to Stage I growth, the Stage II solid layer is formed via a growth interface having a growth direction that is substantially perpendicular to the external surface of the treated mold.

The microstructure of the solid layer (including the Stage I and Stage II solid layers), in addition to its dependence on the temperature gradient of the treated mold and the temperature gradient between the treated mold (including T₁ and T₂, respectively) and the molten semiconducting material, is a function of the rate at which the relative position of the treated mold is changed with respect to the molten semiconducting material. At relatively slow submersion velocities (e.g. on the order of about 1 cm/sec), the temperature differential between the treated mold and the molten semiconducting material is reduced due to heating of the mold, which generally results in the solid layer having relatively large grains but a relatively small total thickness. On the other hand, relatively fast submersion velocities (e.g. on the order of about 50 cm/sec), the relatively high velocity can disturb the shape of the convex meniscus, which can disrupt continuous grain growth and result in the solid layer being discontinuous and having relatively small crystal grains. In embodiments, the submersion rate can be from 0.5 to 50 cm/sec, e.g., 1, 2, 5, 10 or 20 cm/sec. Most typically, the submersion rate is from 10 to 20 cm/sec.

In further embodiments, the submersion rate may be changed (i.e., increased or decreased) during the act of submersion such that the treated mold is accelerated or decelerated.

Quiescent growth of the solid layer during Stage II is a function of the submersion time (i.e., residence time), which, due to the dynamic nature of the exocasting process, will vary spatially over the external surface of the treated mold. The leading edge of the treated mold will be in contact with the molten semiconducting material for a longer time than the trailing edge of the treated mold. This leads to an excess residence time for the leading edge equal to L/Vᵢₙ+L/Vₒᵤₜ, compared to the trailing edge, where L is the length of the mold and Vᵢₙ and Vₒᵤₜ are the submersion and withdrawal velocities. Because the leading edge of the treated mold is the first part of the treated mold to be submersed, initial growth of the Stage II solid layer can be fastest at or near the leading edge where the temperature differential is the greatest. On the other hand, because the leading edge of the treated mold is the last part of the treated mold to be withdrawn, remelting of the Stage II solid layer near the leading edge can decrease the thickness of the solid layer near the leading edge.

The treated mold may be submersed in the molten semiconducting material for a period of time sufficient to allow the solid layer of the semiconducting material to solidify over the external surface of the treated mold. The treated mold may be submersed in the molten semiconducting material for up to 30 seconds or more (e.g. from 0.5 to 30 seconds), alternatively up to 10 seconds (e.g. from 1 to 4 seconds). The submersion time may be varied appropriately based on various parameters, such as the temperatures and heat transfer properties of the system, and the desired properties of the solid layer of the semiconducting material. In embodiments, the “submersion time” refers to the time that any given point on the mold is submersed into the molten semiconducting material. In such embodiments, a submersion time of a point near a leading edge of the mold will be longer than a submersion time of a point near at trailing edge of the mold. In alternate embodiments, such as where the entire mold is submersed into the molten semiconducting material, the “submersion time” may refer to the time that the mold is entirely submersed, i.e., a hold or dwell time.

The time where the transition from solidification to remelting takes place is defined as the “transition time.” The thickness of the Stage II solid layer attains its maximum value at the transition time. According to embodiments, the treated mold can be removed from the molten semiconducting material after a predetermined time that corresponds to the desired thickness of the solid layer.

Additional aspects of the growth and remelting of the solid layer as a function of the submersion time of a mold are described in U.S. patent application Ser. Nos. 12/466,104 and 12/466,143, each filed May 14, 2009, the disclosures of which are hereby incorporated by reference in their respective entireties. Further aspects relating to the submersion and withdrawal of a mold are described in U.S. patent application Ser. No. 12/844,305, filed on Jul. 27, 2010, which is hereby incorporated by reference in its entirety.

During withdrawal of the treated mold from the molten semiconducting material, the wetting dynamics between the solid surface and the molten semiconducting material are generally different from those during submersion. This is because the exposed solid surface of the treated mold is solidified semiconducting material during withdrawal, rather than the original mold material. In the example of molten silicon, a dynamic, concave meniscus forms at the solid-liquid-gas triple point. As a result of this dynamic meniscus, during withdrawal of the treated mold from the molten silicon, an additional solid layer (Stage III solid layer) forms over the previously-formed solid layers (Stage I and Stage II solid layers). The Stage III solid layer is also referred to herein as the overlayer, and determines the minimum thickness of the solid layer obtained through the method.

Although the Stage II solid layer that has formed over the Stage I solid layer will continue to grow or remolten semiconducting material according to the local heat flux dynamics within the molten semiconducting material, the Stage III solid layer forms above the equilibrium surface of the molten semiconducting material due to the wetting of the solid layer (e.g., exposed surface of the Stage II solid layer) by the molten semiconducting material. During withdrawal, a Stage III solid layer growth front is continuously fed by molten material from beneath the dynamic meniscus.

In embodiments, the withdrawal rate can be from about 0.5 to 50 cm/sec, e.g., 1, 2, 5, 10 or 20 cm/sec. Most typically, the withdrawal rate is from 0.5 to 10, alternatively from 3 to 5, cm/sec. Higher withdrawal rates may cause fluid drag that can induce perturbations into the dynamic meniscus, which can be transferred to the Stage III overlayer. In further embodiments, as with the submersion rate, the withdrawal may be changed (i.e., increased or decreased) during the act of withdrawal such that the treated mold is accelerated or decelerated. In one example, during withdrawal of the treated mold a rate of withdrawal is increased from 0 cm/sec to about 3 cm/sec at 10 cm/sec² over 7.5 cm of the treated mold.

After the treated mold is removed from the vessel and sufficiently cooled, the solid layer of the semiconducting material may be removed or separated from the treated mold using, for example, differential expansion and/or mechanical assistance. Alternatively, the solid layer may remain on the external surface of the treated mold as a supported article of semiconducting material. Most typically, the solid layer of the semiconducting material is formed on two external surfaces of the treated mold, which are the major external surfaces of the treated mold and are opposite one another.

The thickness of the solid layer of the semiconducting material is a function of, among other things, the submersion time of the treated mold in the molten semiconducting material. In certain embodiments, the thickness of the solid layer of the semiconducting material is from 100 to 400, alternatively from 125 to 350, alternatively from 150 to 300, alternatively from 175 to 250, microns. Further, solid layer of the semiconducting material has a total thickness variability (TTV) of less than 30, alternatively less than 25, alternatively less than 20, alternatively less than 15, alternatively less than 10, alternatively less than 5, alternatively less than 4, alternatively less than 3, alternatively less then 2, alternatively less than 1, percent. TTV means the normalized maximum difference in thickness between the thickest point and the thinnest point within a sampling area of a solid layer. TTV is equal to (tₘₐₓ−tₘᵢₙ)/t_{target}, where tₘₐₓ and tₘᵢₙ are the maximum and minimum thicknesses within the sampling area and t_{target} is the target thickness. The sampling area may be defined as the whole or a portion of the solid layer.

Conventional exocasting methods suffer from an undesirable TTV due to the difference in the submersion times of the leading edge and the tailing edge of the mold. For example, for a mold having the dimensions 15 cm×15 cm×1.5 mm and a submersion/withdrawal speed of 20 cm/sec, an excess residence time of 1.5 seconds between the leading and trailing edges of the mold results. With an average submersion time of 7.2 seconds, the leading edge of the mold experiences a local submersion time of 7.95 seconds, while the trailing edge of the mold experiences a local submersion time of 6.45 seconds. In such conventional exocasting methods, this variability in local submersion time leads to a thickness of the solid layer adjacent to the leading edge of 215 microns, and a thickness of the solid layer thickness adjacent to the trailing edge of 182 microns, which represents a TTV of 33 microns. However, the method of the instant disclosure obviates such concerns relative to conventional exocasting techniques by minimizing and/or eliminating the TTV of the solid layer of the semiconducting material despite the variability in local submersion times. Specifically, by selectively modifying the temperature gradient of the mold, it is possible to impact the heat transfer kinetics of the exocasting process and offset the residence time dispersion between the leading and trailing edges, thereby minimizing and/or eliminating the TTV of conventional exocasting processes without requiring specialized machining or other manipulation of the mold, e.g., shape of the mold.

The disclosed methods can be used to produce solid layers of semiconducting material having one or more desired attributes related to, for example, total thickness, TTV, impurity content and/or surface roughness. These solid layers, such as silicon sheets, may be used to for electronic devices, e.g. photovoltaic devices. By way of example, an as-formed silicon sheet may have real dimensions of about 156 mm×156 mm, a thickness in a range of 100 μm to 400 μm, and a substantial number of grains larger than 1 mm.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

The following examples are intended to illustrate embodiments and are not to be viewed in any way as limiting to the scope of the disclosure.

### EXAMPLES

### Example 1

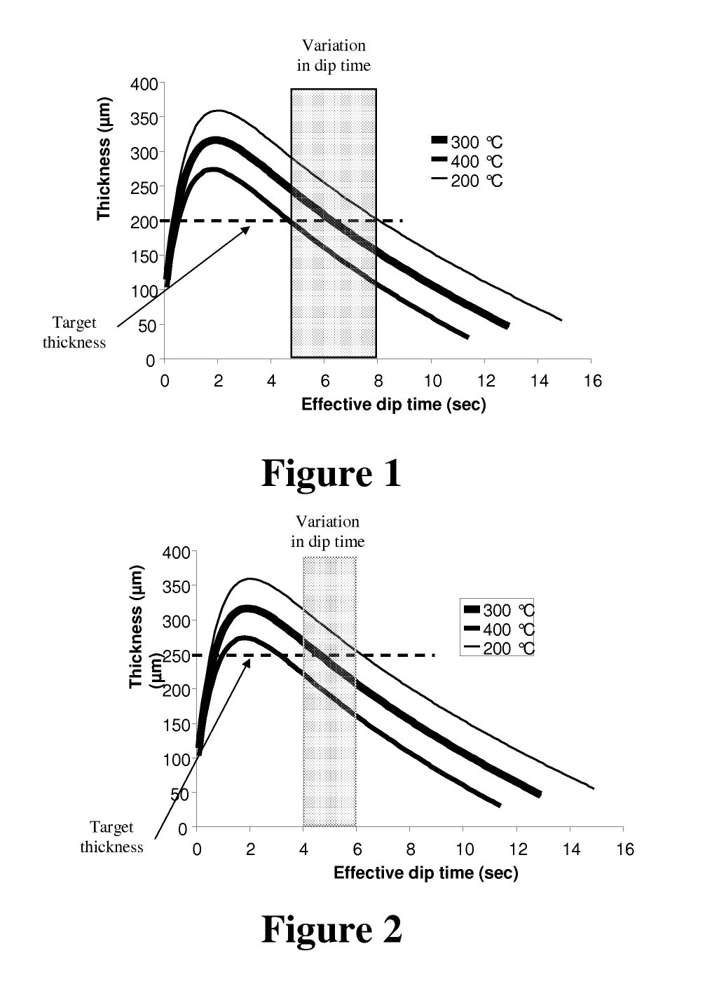

With reference to FIG. 1, a target thickness of a solid layer of a semiconducting material is identified. In FIG. 1, this thickness is 200 microns (μm). Assuming a rate of submersion and a rate of withdrawal of a mold are each 11 centimeters per second (cm/s), the residence time difference between the leading edge and the trailing edge of the mold is 3.6 seconds. For FIG. 1, the mold has dimensions of 15×15×0.2 centimeters (cm), with 0.2 cm being the thickness of the mold. The plots corresponding to various temperatures (i.e., 200, 300, and 400° C.) correspond to the temperature of the mold. As clearly illustrated in FIG. 1, for each of the uniform mold temperatures plotted, the thickness of the solid layer of the semiconducting material various based on the respective residence times of the leading edge and the trialing edge of the mold. For example, relative to a mold having a uniform temperature of 200° C., a variation in the thickness of the solid layer of the semiconducting material is approximately 100 microns (μm). In particular, the solid layer of the semiconducting material would have a thickness of 200 microns (μm) at the leading edge of the mold and a thickness of more than 300 microns at the trailing edge of the mold (assuming the mold has a substantially uniform thickness). Conversely, however, when the temperature of the leading edge of the mold is 200° C., and the temperature of the trailing edge of the mold is 400° C., i.e., when the temperature gradient of the mold is selectively modified to form the treated mold, with linear variation of temperature between the two, a solid layer of semiconducting material having a uniform thickness of approximately 200 microns (μm) is obtained, despite the different residences times of the leading and trailing edges of the treated mold, and despite the fact the treated mold has a substantially uniform thickness and cross sectional area.

### Example 2

With reference to FIG. 2, if the desired thickness of the solid layer of the semiconducting material is 250 microns (μm), and the rate of submersion and the rate of withdrawal of a mold are each 15 centimeters per second (cm/s), the residence time difference between the leading edge and the trailing edge of the mold is 2 seconds. For FIG. 2, the mold has dimensions of 15×15×0.2 centimeters (cm), with 0.2 cm being the thickness of the mold. The plots corresponding to various temperatures (i.e., 200, 300, and 400° C.) correspond to the temperature of the mold. As clearly illustrated in FIG. 2, for each of the uniform mold temperatures plotted, the thickness of the solid layer of the semiconducting material various based on the respective residence times of the leading edge and the trialing edge of the mold. For example, relative to a mold having a uniform temperature of 200° C., a variation in the thickness of the solid layer of the semiconducting material is less than 100 microns (μm) (due to the increased rate of submersion and rate of withdrawal, and assuming the mold has a substantially uniform thickness). Conversely, however, when the temperature of the leading edge of the mold is 200° C., and the temperature of the trailing edge of the mold is 350° C., i.e., when the temperature gradient of the mold is selectively modified to form the treated mold, with linear variation of temperature between the two, a solid layer of semiconducting material having a uniform thickness of approximately 250 microns (μm) is obtained, despite the different residences times of the leading and trailing edges of the treated mold, and despite the fact the treated mold has a substantially uniform thickness and cross sectional area.

### Example 3

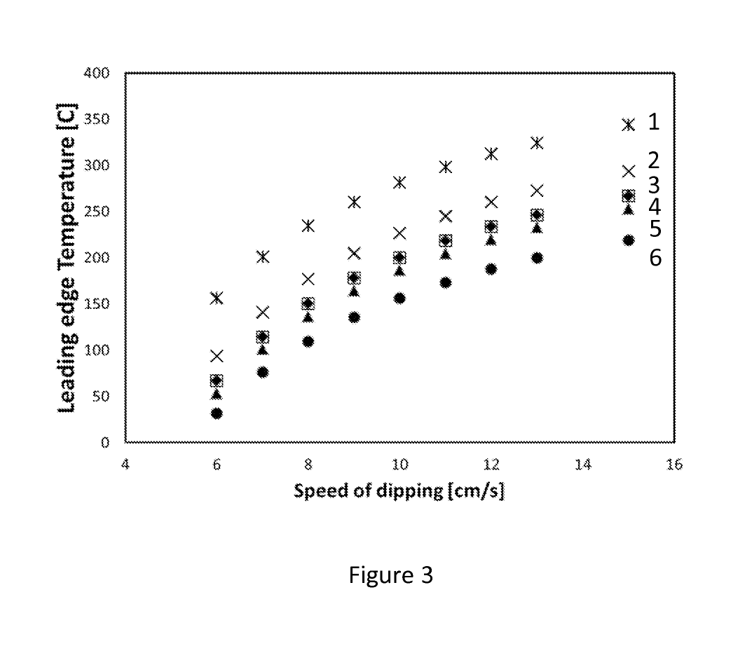

A modeled plot of leading edge temperature versus submersion rate is shown in FIG. 3. The data provide insight into process controls that may be used to minimize TTV by implementing a mold temperature gradient. The illustrated data assume a 2.5 mm thick, 15 cm square silica mold. The trailing edge temperature is fixed at 400° C. The total process mold submersion time and time dispersion (submersion time difference between the leading and trailing edges) are accounted for in the x-axis (dipping speed). In FIG. 3, curves 1 and 6 correspond respectively to a TTV of −30 microns and +30 microns for a solid layer having a target thickness of 250 microns (hold time of 3 sec). Curves 1 and 6, which correspond to a maximum allowable TTV according to example embodiments, provide upper and lower bounds on various example processes. Curves 2 and 5 correspond respectively to a TTV of +10 microns and −10 microns for a solid layer having a target thickness of 250 microns (hold time of 3 sec). Curves 3 and 4 correspond to a 250 micron target thickness (hold time of 3 sec and 4.7 sec, respectively).

Each set of data in FIG. 3 estimate the temperature of the leading edge under various conditions, given that the trailing edge temperature is assumed constant at 400° C. and the silicon melt is assumed initially fixed at 1410° C. Thus, curves 3 and 4 indicate the leading edge temperature needed to form a silicon sheet having a thickness of 250 microns using a hold time of 3.5 and 4.7 seconds, respectively. These two curves represent estimates based on achieving zero percent tolerance of the silicon sheet. If some variation in the thickness is desired, the remaining curves indicate the corresponding leading edge temperatures for the given tolerances.

As used herein, the singular forms “a,” “an” and “the” include plural referents unless the context clearly dictates otherwise. Thus, for example, reference to a “solid layer” includes examples having two or more such “solid layers” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

What is claimed is:

1. A method of treating a mold to form a treated mold for use in forming an article of a semiconducting material on an external surface of the treated mold, the mold extending between a leading edge and a trailing edge, said method comprising:
selectively modifying a temperature gradient of the mold such that a temperature of the leading edge (T₁) is less than a temperature of the trailing edge (T₂) to form the treated mold.

2. A method as set forth in claim 1, wherein the temperature of the leading edge is at least 50° C. less than a temperature of the trailing edge.

3. A method as set forth in claim 1, wherein T₁ is from 150 to 250° C. and T₂ is from 300 to 500° C.

4. A method as set forth in claim 1, wherein (a) the treated mold has a substantially uniform thickness between the leading edge and the trailing edge; (b) the treated mold comprises a material selected from fused silica, graphite, silicon nitride, single crystal silicon, polycrystalline silicon, and combinations thereof; or (c) both (a) and (b).

5. A treated mold formed in accordance with the method of claim 1.

6. A method of forming a solid layer of a semiconducting material on an external surface of a treated mold, said method comprising the steps of:
selectively modifying a temperature gradient of a mold which extends between a leading edge and a trailing edge such that a temperature of the leading edge (T₁) is less than a temperature of the trailing edge (T₂) to form the treated mold;
submersing the treated mold into a molten semiconducting material such that the leading edge of the treated mold is first submersed into the molten semiconducting material; and
withdrawing the treated mold from the molten semiconducting material such that the leading edge of the treated mold is last withdrawn from the molten semiconducting material to form the solid layer of the semiconducting material on the external surface of the treated mold.

7. A method as set forth in claim 6, wherein the treated mold has a substantially uniform thickness between the leading edge and the trailing edge.

8. A method as set forth in claim 6, wherein the solid layer of the semiconducting material has (a) a total thickness variability of less than 30%; (b) a total thickness variability of less than 15%; or (c) a total thickness variability of less than 5%.

9. A method as set forth in claim 6, wherein T₁ is from 150 to 250° C. and T₂ is from 300 to 500° C.

10. A method as set forth in claim 6, wherein the treated mold is submersed at a substantially constant rate and withdrawn at a substantially constant rate.

11. A method as set forth in claim 6, wherein a rate of submersion and a rate of withdrawal are each independently from 0.5 to 50 cm/sec.

12. A method as set forth in claim 6, wherein the treated mold is submersed along at least 90% of an entire length of the treated mold extending between the leading edge and the trailing edge.

13. A method as set forth in claim 6, wherein the treated mold comprises a material selected from the group of fused silica, graphite, silicon nitride, silicon carbide, single crystal silicon, polycrystalline silicon, and combinations thereof.

14. A method as set forth in claim 6, wherein the solid layer of the semiconducting material has an average thickness of from 100 to 400 microns.

15. A method as set forth in claim 6, wherein the solid layer of the semiconducting material comprises polycrystalline silicon.

16. A method as set forth in claim 6, wherein the treated mold has a thickness of from 0.05 to 0.50 cm along an entire length of the treated mold extending between the leading edge and the trailing edge, a rate of submersion and a rate of withdrawal are each independently from 3 to 20 cm/sec, T₁ is from 150 to 250° C., and T₂ is from 300 to 500° C.

17. A solid layer of a semiconducting material formed in accordance with the method of claim 6.
